(19) United States
(12) Patent Application Publication
(10) Pub. No.: US 2005/0050183 A1
(43) Pub. Date: Mar. 3, 2005

(54) Method, system and storage medium for managing open grid service architecture services

(75) Inventors: Robert C. Hansen, Johnson City, NY (US); Frank V. Paxhia, Salt Point, NY (US)

Correspondence Address: Philmore H. Colburn II;CANTOR COLBURN LLP, 55 Griffin Road South, Bloomfield, CT, 06002, US

(73) Assignee: International Business Machines Corporation, Armonk, NY (US)

(21) Appl. No.: 10/650,299

(22) Filed: Aug. 27, 2003

(51) Int. Cl. G06F 15/173

(52) U.S. Cl. 709/223

(57) ABSTRACT

An embodiment of the invention is a method for managing open grid service architecture (OGSA) services. The method includes establishing an open grid service infrastructure (OGSI) instance including an OGSA container. An OGSA service is established along with and an OGSA service descriptor including an OGSA container attribute needed for the OGSA service. The OGSA service is deployed to the OGSI instance and the OGSA container attribute is compared to a characteristic of the OGSA container. The OGSA service is supported on the OGSA container if the attribute matches the characteristic.

### BACKGROUND OF THE INVENTION

The invention relates generally to grid computing and in particular to managing one or more open grid services architecture (OGSA) services implemented on open grid services infrastructure (OGSI) instances.

Grid computing enables the virtualization of distributed computing and data resources such as processing, network bandwidth and storage capacity to create a single system image, granting users and applications seamless access to vast IT capabilities. Just as an Internet user views a unified instance of content via the Web, a grid user essentially sees a single, large virtual computer.

At its core, grid computing is based on an open set of standards and protocols referred to as an Open Grid Services Architecture (OGSA). The OGSA enables communication across heterogeneous, geographically dispersed environments. With grid computing, organizations can optimize computing and data resources, pool them for large capacity workloads, share them across networks and enable collaboration.

To provide grids services, OGSI instances are established on a server instance having an OGSA. As the number and types of grid services increases, creating, configuring and managing the OGSI instances becomes a daunting task. Thus, applications for facilitating OGSI management and deploying OGSA services are needed.

### BRIEF DESCRIPTION OF THE INVENTION

An embodiment of the invention is a method for managing open grid service architecture (OGSA) services. The method includes establishing an open grid service infrastructure (OGSI) instance including an OGSA container. An OGSA service is established along with and an OGSA service descriptor including an OGSA container attribute needed for the OGSA service. The OGSA service is deployed to the OGSI instance and the OGSA container attribute is compared to a characteristic of the OGSA container. The OGSA service is supported on the OGSA container if the attribute matches the characteristic.

### BRIEF DESCRIPTION OF THE DRAWINGS

Referring to the exemplary drawings wherein like elements are numbered alike in the several Figures:

FIG. 1 depicts an exemplary grid computing system;

FIGS. 2-10 depict exemplary user interfaces for managing open grid services.

### DETAILED DESCRIPTION OF THE INVENTION

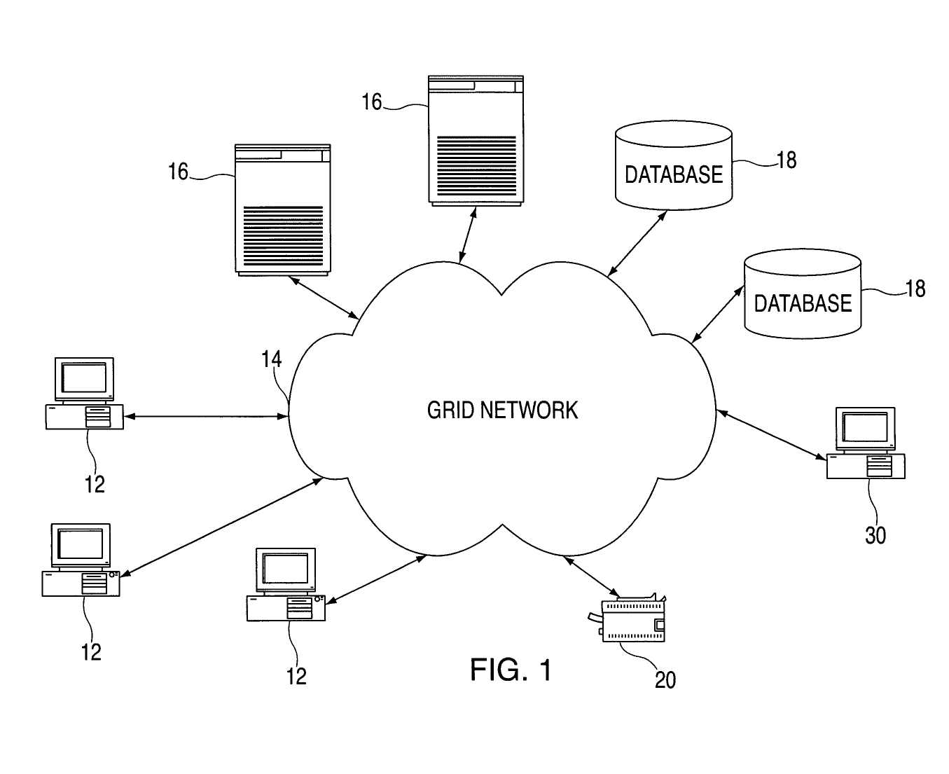

FIG. 1 depicts an exemplary grid computing system for implementing embodiments of the invention. The grid computing system includes a plurality of user systems 12 for accessing grid services. Each user system 12 may be implemented using a general-purpose computer executing a computer program for carrying out the processes described herein. The user system 12 may be any other device capable of communicating over grid network 14 (e.g., a personal digital assistant, dumb terminal).

The user systems 12 are connected to grid network 14. The grid network 14 may be a collection of multiple, geographically dispersed networks including LAN, WAN, Internet, VPN, etc. Grid network 14 may include wired and wireless network components. A number of grid resources are connected to the grid network 14 to support OGSA services. Such grid resources include servers 16, databases 18, printers 20, etc. Any physical component needed to provide grid services may be coupled to the grid network 14.

An administrative system 30 is also coupled to grid network 14. The administrative system 30 may be implemented using a general-purpose computer executing a computer program for carrying out the processes described herein. The administrative system 30 may be any other device capable of communicating over grid network 14 (e.g., a personal digital assistant, dumb terminal). The administrative system 30 accesses a grid services application referred to herein as a deploy, configure, manage and administer (DCMA) application. The DCMA application may be resident on administrative system 30 or accessed from a grid resource over grid network 14. The DCMA application allows an administrator to install, configure and manage requisite OGSI instances on one or more grid resources (e.g., servers 16) and deploy OGSA services.

The DCMA application is comprised of several parts. A user interface component may be based on the J2EE UI model which includes a web browser client communicating with servlets, Java Server Pages (JSPs), and other standard web content. The DCMA application is capable of accessing a variety of web resources such as a web portals (e.g., the WebSphere Integrated Solutions Console from IBM). The DCMA application also provides utility services for deployment and configuration of base and core OGSA services.

The DCMA allows an administrator to deploy grid services to OGSI instances to on the grid network. An OGSI instance contains the operating environment that is required of services that are deployed on top of it. The OGSI instance may be deployed across multiple grid resources. For example, in a Websphere environment, an OGSI instance is deployed to one or more server instances. Multiple OGSI instances are allowed per operating system instance. This enables grid services to be deployed to separate OGSI instances, facilitating a form of application independence (e.g., applications do not share address space). Each OGSI instance may be installed and configured separately. Alternatively, the administrative system 30 may serve as a central point for configuration and broadcast of the required software code to each of the OGSI instances in the grid network.

Grid services that define the OGSA functionality are implemented using java beans, java support classes, web content and a set of services that need to be deployed. In J2EE terms, this functionality is packaged in an Enterprise Application Archive (EAR file) that is built when using the OGSA tooling when an OGSA compliant service is created by a service provider.

The DCMA application provides a deploy utility that will deploy OGSI instances along with OGSA services to a server instance specifically created for OGSA. During the deploy process, a series of items are configured to establish the operating environment. Once EAR files have been deployed, some additional configuration is used to create the proper web context for the application.

The DCMA application includes a user interface to manage the attributes of the OGSI instances running on the operating system instance that the user interface is being served from. This will include altering those properties that are required to by each OGSI Instance. Examples of OGSI attributes that may be managed include the port that an HTTP server is listening on, properties of embedded JMS provider messaging, properties of what is required for notification setup, and attributes required to conform to JSR 101, 109. Further attributes include the information required to setup security for access to grid resources.

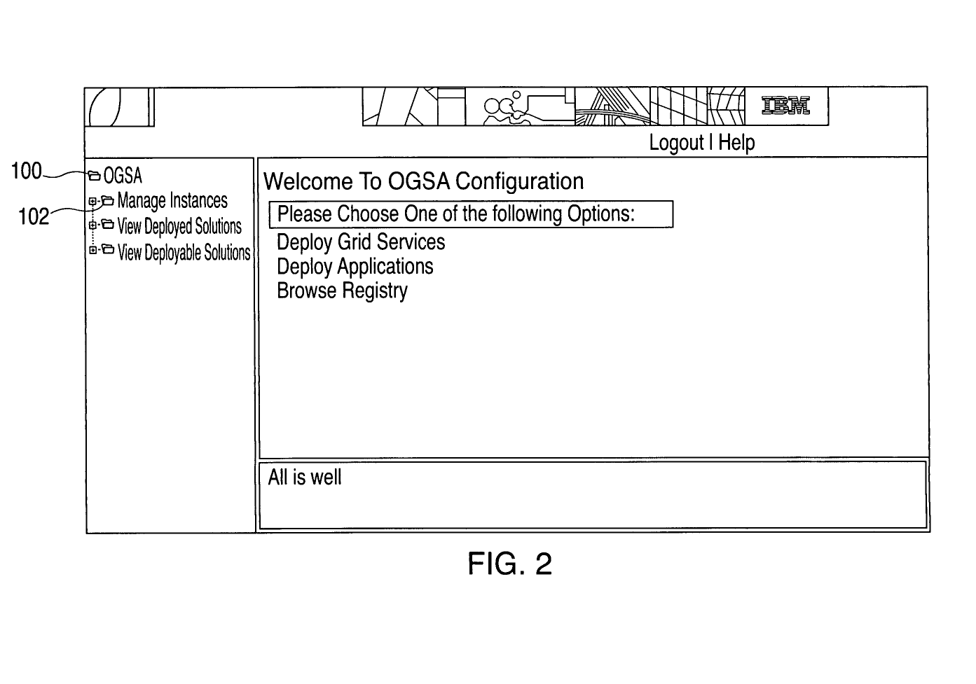

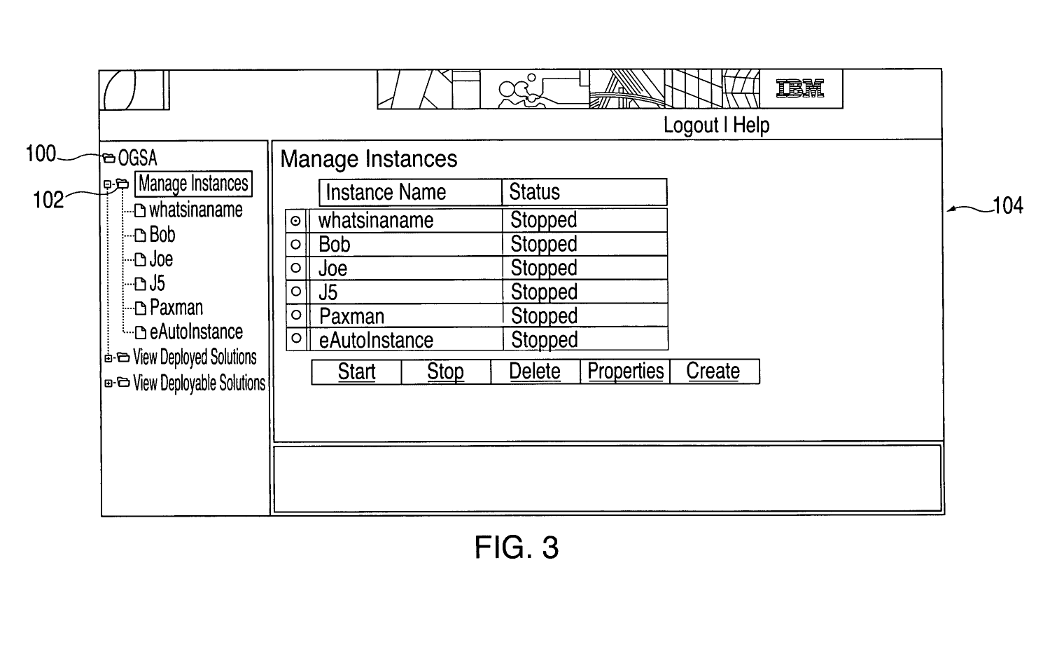

FIGS. 2-10 depict exemplary user interfaces provided on administrative system 30 by the DCMA application. FIG. 2 depicts a main OGSA user interface generated by the DCMA application. Through the main user interface, an administrator can deploy, configure, manage and administer OGSA services. An OGSA folder 100 includes a manage instances subfolder 102 identifying existing OGSI instances. By expanding the manage instance folder 102, the configured OGSI instances are shown in a tree (see FIG. 3) and are available for further actions such as deploying services or browsing registries.

FIG. 3 shows a manage instances user interface generated upon selection of the manage instances subfolder 102. The existing instances are shown in a tree format beneath the manage instances subfolder 102. A manage instance window 104 presents a list of OGSI instances including OGSI instance name and status. The OGSA folder view allows the administrator to start execution of an OGSI instance, stop execution of an OGSI instance, delete an OGSI instance, obtain properties of an OGSI instance or create an OGSI instance. The manage instance window 104 allows the management on a per OGSI instance basis and also allows the creation and deletion of an OGSI instance.

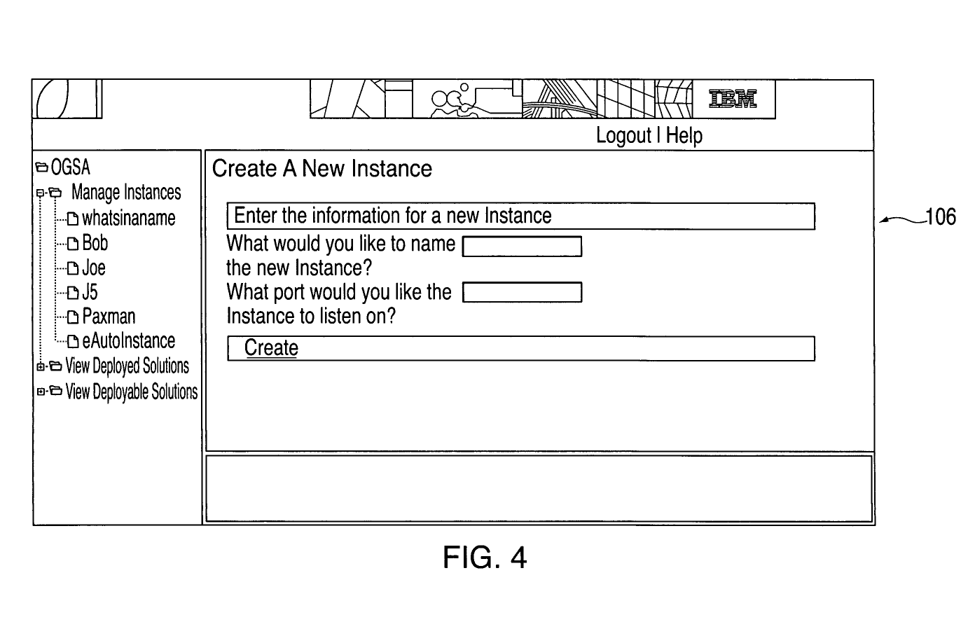

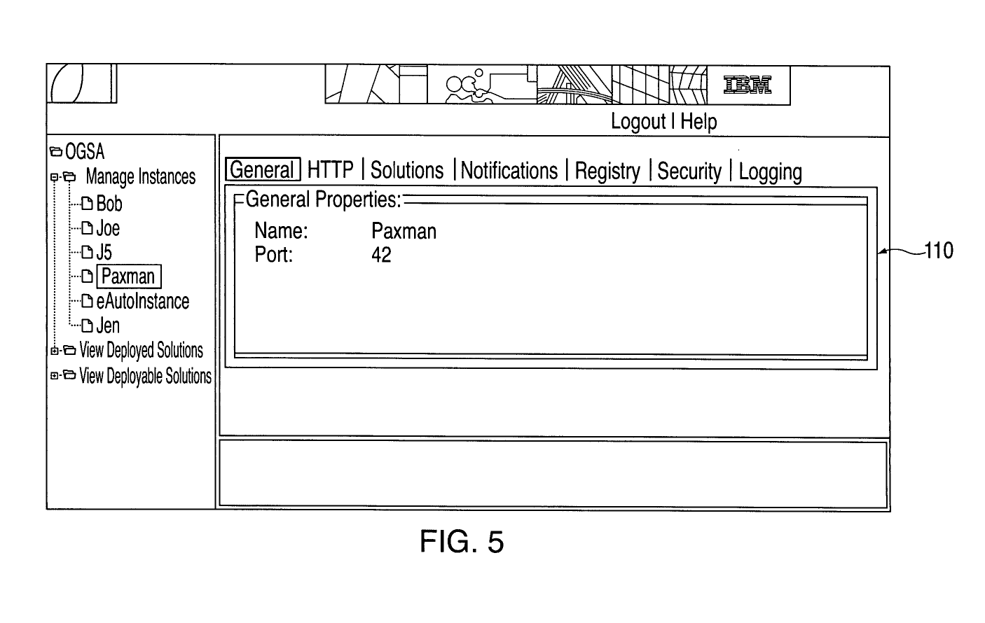

If the create an instance function is selected from the manage instance window 104, a wizard is launched that requests aspects of the creation of a new OGSI instance. FIG. 4 depicts a create instance window 106. To create an OGSI instance, the administrator provides an OGSI instance name and a port of a server 16 that will serve as an access point for the OGSI instance to users systems 12. That data is filled in and the “Create” button is selected. The administrator is given an indication at administrator system 30 whether the operation was either successful or not. Once an OGSI instance is created, one can view the properties of the instance in a tabbed OGSI instance properties window 110 as shown in FIG. 5.

The DCMA application also provides management facilities for OGSA deployable services. An OGSA deployable solution refers to OGSA services that are installed on an operating system instance, (e.g., in the installable applications directory) but not yet deployed. The DCMA application also provides management facilities for OGSA deployed solutions which refers to OGSA services that have been deployed.

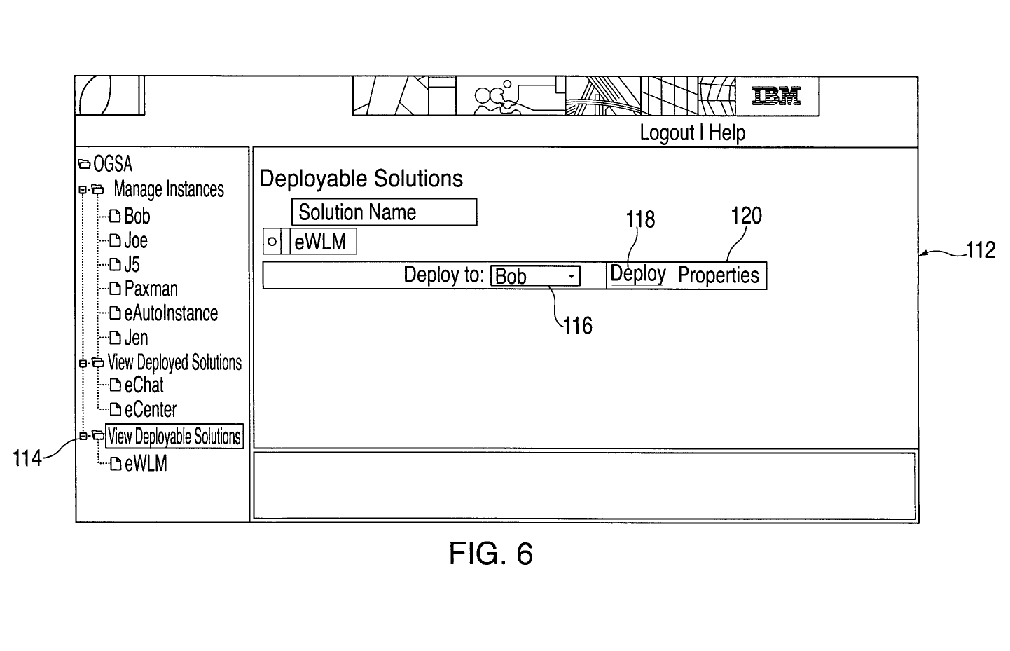

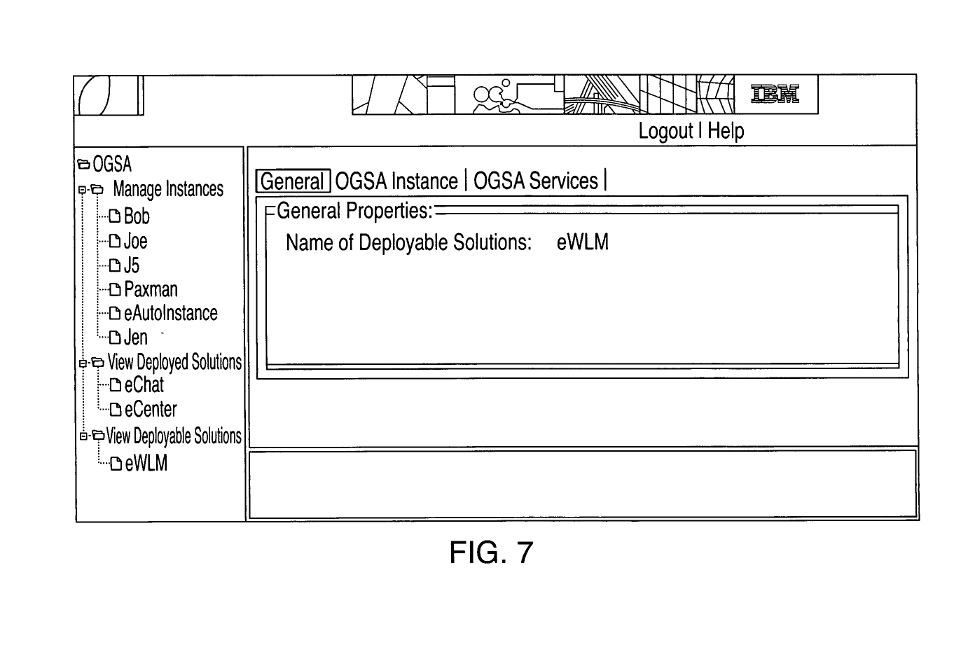

FIG. 6 shows an OGSA deployable services window 112 which is generated upon selecting a view deployable solutions folder 114. Through the OGSA deployable services window 112, the administrator can select a deployable OGSA service to be deployed by name. A recipient of the OGSA deployable service may be selected from a drop down menu 116. Once the OGSA deployable service is identified by name and the recipient is identified, the OGSA deployable service is deployed by selection of a deploy icon 118. Selection of properties icon 120 in FIG. 6 generates a OGSA deployable service properties window as shown in FIG. 7. The OGSA deployable service properties window provides the administrator with information concerning the OGSA deployable service.

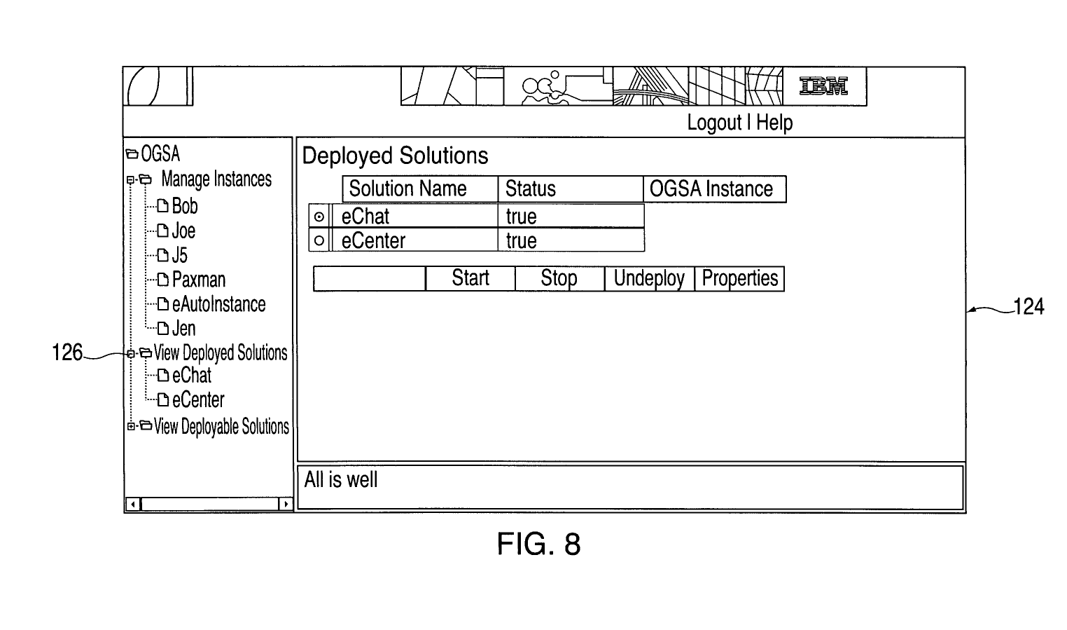

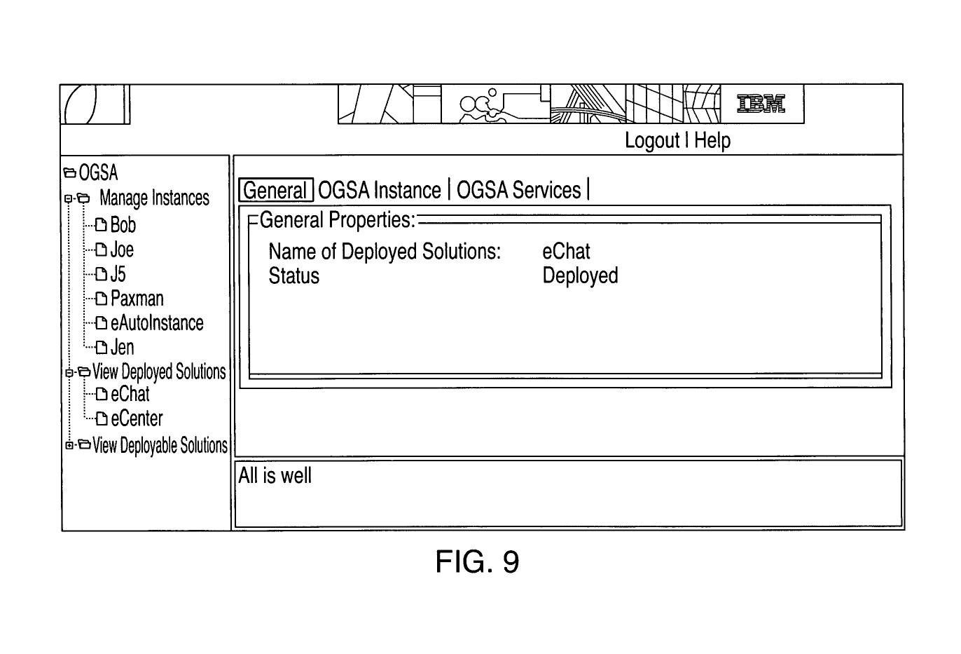

FIG. 8 shows an OGSA deployed service window 124 which is generated upon selecting a view deployed services folder 126. Through the OGSA deployed service window 124, the administrator can select a deployed OGSA service by name and initiate actions such as starting, stopping or undeploying the OGSA service. The start command instructs the grid resources supporting the OGSA service (e.g., server 16) to launch the OGSA service. Conversely, the stop command instructs the grid resources supporting the OGSA service (e.g., server 16) to stop the OGSA service. The undeploy command retrieves a deployed OGSA service from one or more grid resources. The OGSA service must then be deployed again to be accessed by users. Properties of OGSA services may be viewed upon selecting a properties icon in FIG. 8. An exemplary OGSA deployed service properties window is shown in FIG. 9.

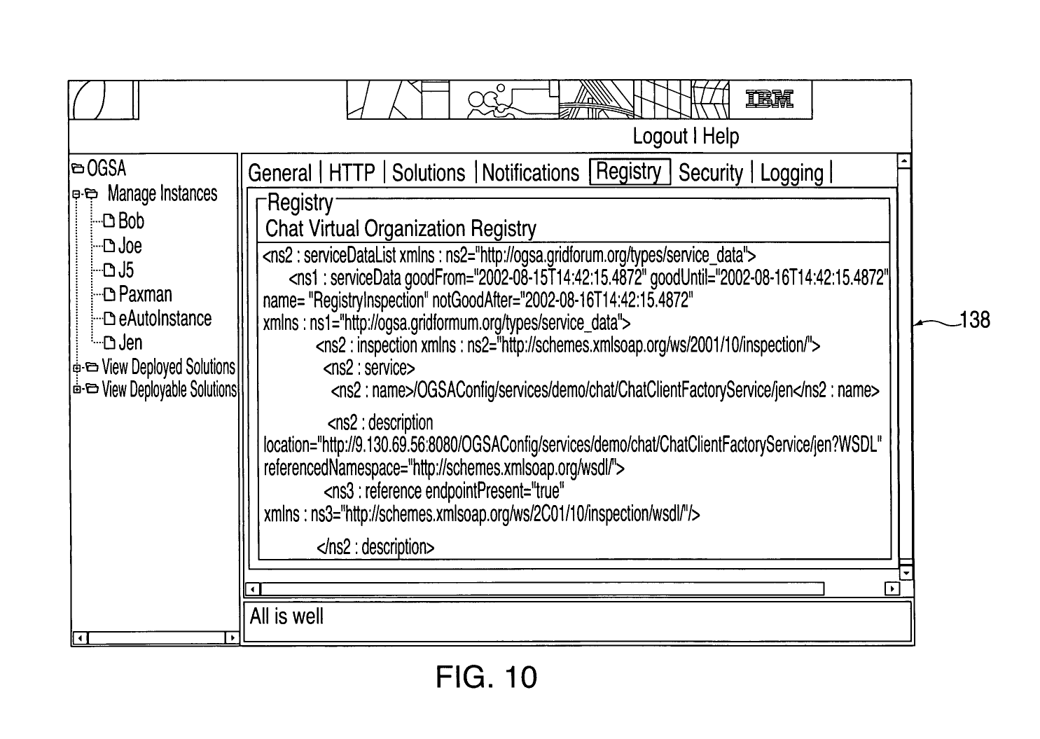

FIG. 10 shows an OGSA registry view window 138 which is accessed by selecting a registry tab from the main OGSA folder 100 in FIG. 2. Through the OGSA registry view window 138, the administrator can manage the OGSA registry data through operations such as view, change, etc. for data that is relevant.

When creating or deploying an OGSA service, a service descriptor is created defining information about the OGSA service that is to be deployed and the attributes of the OGSA container required to run the services. An OGSA container is part of the OGSI instance and provides the programming interfaces that OGSA services rely on in the operating environment. The OGSA container provides facilities that OGSA services can use to implement the OGSA services. These services provide the base functionality of the OGSA container.

The OGSA service descriptor may be a text file (e.g., in xml format) that includes information about the OGSA service such as name, supporting classes, version information, etc. The service descriptor also includes OGSA container attributes such as minimum version of the container required, dependant software or services that are required, additional configuration needs that the OGSA service may require that the OGSA container can provide, and a method for the services to do any other configuration that OGSA service may require (e.g., specifying a java interface to be called at runtime).

When the OGSA service is deployed to a grid resources (e.g., server), the attributes of the service descriptor associated with the OGSA service are compared with OGSA container characteristics to confirm that the OGSA container can support the OGSA service. If the attributes in the service descriptor match the characteristics of the OGSA container, the OGSA service is implemented by the OGSA container supported by the OGSI instance. If not, the OGSA container may be reconfigured to add components needed by the OGSA service. If reconfiguration is not possible, then an error message is provided back to the administrator system to indicate that deployment of the OGSA service was not possible. At this stage, the administrator may configure a new OGSI instance and associated OGSA container to support the OGSA service.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for managing open grid service architecture (OGSA) services comprising:
establishing an open grid service infrastructure (OGSI) instance including an OGSA container;
establishing an OGSA service and an OGSA service descriptor including an OGSA container attribute needed for said OGSA service;
deploying said OGSA service to said OGSI instance;
comparing OGSA container attribute to a characteristic of said OGSA container; and,
supporting said OGSA service on said OGSA container if said attribute matches said characteristic.

2. The method of claim 1 further comprising:
reconfiguring said OGSA container if said attribute does not match said characteristic to support said OGSA service.

3. The method of claim 1 further comprising:
generating an error message if said attribute does not match said characteristic.

4. The method of claim 1 further comprising:
providing a user interface for managing OGSI instances, said user interface providing a tool for creating an OGSI instance for supporting OGSA services.

5. The method of claim 4 wherein:
said creating said OGSI instance includes identifying a port of a grid resource to support said OGSI instance.

6. The method of claim 1 further comprising:
providing a user interface for said deploying said OGSA service, said user interface including a tool for undeploying said OGSA service.

7. A system for managing open grid service architecture (OGSA) services comprising:
an administrator system establishing an open grid service infrastructure (OGSI) instance including an OGSA container;
a grid network coupled to said administrator system;
a grid resource coupled to said grid network;
said administrator system establishing an OGSA service and an OGSA service descriptor including an OGSA container attribute needed for said OGSA service;
said administrator system deploying said OGSA service to said OGSI instance;
said grid resource comparing said OGSA container attribute to a characteristic of said OGSA container; and,
said grid resource supporting said OGSA service on said OGSA container if said attribute matches said characteristic.

8. The system of claim 7 further comprising:
said grid resource reconfiguring said OGSA container if said attribute does not match said characteristic to support said OGSA service.

9. The system of claim 7 further comprising:
said grid resource generating an error message if said attribute does not match said characteristic.

10. The system of claim 7 further comprising:
said administrator system providing a user interface for managing OGSI instances, said user interface providing a tool for creating an OGSI instance for supporting OGSA services.

11. The system of claim 10 wherein:
said creating said OGSI instance includes identifying a port of a grid resource to support said OGSI instance.

12. The system of claim 7 further comprising:
said administrator system providing a user interface for said deploying said OGSA service, said user interface including a tool for undeploying said OGSA service.

13. A medium encoded with a machine-readable computer program code for managing open grid service architecture (OGSA) services, said medium including instructions for implementing the method comprising:
establishing an open grid service infrastructure (OGSI) instance including an OGSA container;
establishing an OGSA service and an OGSA service descriptor including an OGSA container attribute needed for said OGSA service;
deploying said OGSA service to said OGSI instance;
comparing OGSA container attribute to a characteristic of said OGSA container; and,
supporting said OGSA service on said OGSA container if said attribute matches said characteristic.

14. The method of claim 13 further comprising instructions for implementing:
reconfiguring said OGSA container if said attribute does not match said characteristic to support said OGSA service.

15. The method of claim 13 further comprising instructions for implementing:
generating an error message if said attribute does not match said characteristic.

16. The method of claim 13 further comprising instructions for implementing:
providing a user interface for managing OGSI instances, said user interface providing a tool for creating an OGSI instance for supporting OGSA services.

17. The method of claim 16 wherein:
said creating said OGSI instance includes identifying a port of a grid resource to support said OGSI instance.

18. The method of claim 13 further comprising instructions for implementing:
providing a user interface for said deploying said OGSA service, said user interface including a tool for undeploying said OGSA service.
